(19) United States
(12) Patent Application Publication
(10) Pub. No.: US 2011/0033613 A1
(43) Pub. Date: Feb. 10, 2011

(54) Method and Composition for Protection of Refractory Materials in Aggressive Environments

(75) Inventors: Josef Matyas, Richland, WA (US); S. Kamakshi Sundaram, Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: BATTELLE MEMORIAL INSTITUTE, Richland, WA (US)

(21) Appl. No.: 12/535,006

(22) Filed: Aug. 4, 2009

(51) Int. Cl. B05D 7/14; C09K 15/02

(52) U.S. Cl. 427/142; 252/397

(57) ABSTRACT

A method and composition are disclosed that provide protection of refractory materials used, e.g., in kiln and slagging coal-gasifier operations. Inert high-temperature melting crystalline compounds and glasses are used to fill defects on the surface and/or interior of the refractory material. At the operation temperatures, the inert crystalline compound mixes with slag and increases the viscosity and melting point temperature, reducing the ability of the slag to penetrate into the refractory, which minimizes breakdown of the refractory material. The same scheme can potentially be applied to sealing of geological formations, e.g., for CO₂ sequestration, and repairing of engineering materials currently in service while continuing to operate in aggressive environments.

This invention was made with Government support under Contract DE-AC0576RLO-1830 awarded by the U.S. Department of Energy. The Government has certain rights in the invention.

### FIELD OF THE INVENTION

The present invention relates generally to refractory materials for coal gasification that generates corrosive slags. More particularly, the invention relates to methods and compositions for protection of refractory materials and refractory surfaces. The invention finds application in, e.g., coal gasifiers for production of synthetic fuels (e.g., syngas) and like applications.

### BACKGROUND OF THE INVENTION

Issues related to reliability and economics of slagging gasifier operation restrict widespread use of coal gasification technology. Central to both enhanced reliability and economics is the development of materials with longer service lives that can provide extended periods of trouble-free gasifier operation. High-chromia refractories (Serv 95®, Zirchrom 60®, Zirchrom 900®, and Aurex 75SR®) are currently the few refractory materials that can survive harsh environments inside a gasifier. These materials resist dissolution in molten slag due to their low chemical solubility in gasifier slags. However, they do not provide as good a resistance to large-scale material losses that result from spalling, due to the corrosive nature of slags (e.g., low-viscosity slags) and the high open porosity of the refractory. During combustion of coal, mineral constituents of the coal are converted into a molten slag typically containing SiO₂, FeO, CaO, and Al₂O₃. Slag flows down the walls of the gasifier, penetrates the refractory material, and then reacts with, and corrodes, the refractory material. Slag penetration into a refractory material occurs through interconnected pores and cracks found along grain boundaries parallel to the hot face of the gasifier. Penetration by the slag initiates and promotes the growth of cracks in the slag-penetrated region and near the boundary between the slag-penetrated region and the virgin refractory material. Cracks can join and cause large pieces of refractory material to be removed in the flowing slag. Service life of high-chromia refractory linings that protect the steel shell of slagging gasifiers ranges from 4 to 18 months due to: 1) non-optimized operating conditions and feedstocks; 2) elevated temperatures of a gasifier (1300° C.-1600° C.); 3) elevated pressures up to 1500 KPa (1.1×10⁴ Torr); and 4) corrosive attack by coal slag. Failure of today's refractory linings in slagging gasifiers is expensive both in terms of refractory replacement costs (upwards of $1 M depending on shell size and extent of the required rebuild) and production downtime. Re-lining of a gasifier requires a complete shut-down of the gasifier system. A rebuild typically involves a cool-down period (4-6 days), removal of the refractory, and refractory installation (3 days for a partial re-line, 7 to 10 days for a full re-line). Under a best-case scenario, even a partial rebuild of a gasifier can be expected to take up to 7 days, leading to significant costs. Given these considerations, new methods and compositions are needed that minimize corrosion in refractory materials and increase the service lifetime of the refractory materials in the gasifier.

### SUMMARY OF THE INVENTION

In one aspect, the invention includes a refractory protection composition that protects refractory materials and refractory surfaces. The refractory protection composition includes at least about 10% by weight of a dried and/or densified impregnation material that is in an amorphous, crystalline, and/or polycrystalline form impregnated within defects on the surface and/or the interior of a refractory. The dried and/or densified impregnation material includes compounds selected from, e.g., leucite (KAlSi₂O₆), mullite (Al₆Si₂O₁₃), AlN, silica (e.g., cristobalite, tridymite, and other polymorphs of silica), SiAlON, Si₃N₄, and combinations of these compounds. The refractory protection composition can further include high melting temperature glasses including, but not limited to, e.g., potassium aluminosilicate glasses, silica glasses, and combinations of these glasses. These amorphous, crystalline, and/or polycrystalline compounds have a melting temperature in the range from about 1600° C. to about 2200° C. The refractory protection composition when applied to a refractory as an impregnation material at least partially fills defects on the surface and/or the interior of the refractory including, but not limited to, e.g., flaws; cracks; pores; interconnected pores; inclusions; occlusions; cavities; channels; depressions; grooves; holes; features; including combinations of these defects. The protection composition when applied to the refractory impregnates the refractory with amorphous, crystalline, or polycrystalline compounds that substantially increase the viscosity of slag that contacts the impregnated refractory, significantly reducing the ability of the slag to penetrate (or further penetrate) the refractory and induce spalling of the refractory. The impregnation material is reactive towards slag and increases the viscosity of the slag melt by at least an order of magnitude. The crystalline materials in the protection composition also increase the melting temperature of slag that contacts the refractory material by at least about 100° C. Thus, the impregnated protection composition in the refractory fills defects on the surface and/or the interior of the refractory with amorphous, crystalline, or polycrystalline compounds that can increase the service lifetime of the refractory material, e.g., in a coal-gasifier to 5 years or more. In one embodiment, the crystalline compound is leucite (KAlSi₂O₆). The densified impregnation material preferably contains greater than or equal to about 30 wt % leucite crystals and less than or equal to about 70 wt % of an amorphous potassium aluminosilicate glass matrix. In another embodiment, the crystalline compound is mullite (Al₆Si₂O₁₃), with a concentration of mullite crystals of 100 wt %. In other embodiments, the crystalline compound is 100 wt % silica or silica containing at least about 10 wt % cristobalite and/or tridymite phases within the silica glass matrix; 100 wt % SiAlON; 100 wt % AlN; or 100 wt % Si₃N₄. In a preferred embodiment, the refractory protection composition is prepared as a sol-gel mixture that is impregnated using a sol-gel method. In this method, sol particles (i.e. nanoparticles) of the impregnation material are introduced into a preselected quantity of a solvent (e.g., water) to form a low-viscosity sol-gel or low-viscosity colloidal solution. Viscosity of the sol-gel mixture is preferably in the range from about 1 Pa.s to about 2 Pa.s, but is not limited thereto. The refractory material is impregnated (treated) with the sol-gel to fill or partially fill defects of the refractory material, thereby forming an impregnated refractory material. In another step, the impregnated refractory material can be densified through a combined thermal drying and densification step that turns the impregnated refractory material into an amorphous, crystalline, or polycrystalline protection material. When dried and/or densified at preselected temperatures, the densified crystalline compounds (impregnation material) in the refractory become amorphous, crystalline, or polycrystalline, and increase the viscosity and/or the melting point temperature of a slag that contacts the densified crystalline compounds, thereby minimizing the ability of the slag to penetrate the refractory and cause spelling at an operating temperature of, e.g., a slagging coal gasifier. Drying temperatures are preferably selected above about 50° C. Densification temperatures can be selected in the range from about 110° C. to about 1500° C. The refractory protection composition can further include high melting point glasses including, but not limited to, e.g., potassium aluminosilicate glasses, silicate glasses, and combinations of these glasses. In one embodiment, the solvent is an aqueous solvent, e.g., water (H₂O). In a preferred embodiment, the sol-gel mixture has a viscosity below about 2 Pa.s. In another embodiment, the sol-gel mixture has a viscosity of from about 1 Pa.s to about 2 Pa.s. The sol-gel and colloidal mixtures can include sols of various sizes. Sols of the sol-gel and colloidal mixtures can range in size from about 10 nm to about 100 nm, but are not limited thereto.

In another aspect, the invention includes a method for protection of a refractory material. The method includes the step of: impregnating at least a portion of a defect on the surface and/or the interior of the refractory material with an impregnation material to form an impregnated refractory material. The introduced impregnation material increases the viscosity and/or the melting temperature of the slag material that contacts the impregnated refractory material. The increase in viscosity of the slag decreases the ability of the slag to penetrate into the refractory at the selected operating temperature, which minimizes spalling of the refractory material. In one embodiment, the step of impregnating includes contacting the refractory material with a sol-gel mixture of a preselected composition for a preselected time to form an impregnated refractory material. The sol-gel mixture is a low viscosity sol-gel. In one embodiment, the sol-gel is a leucite sol-gel that contains: 21.58 wt % K₂O, 23.36 wt % Al₂O₃, and 55.06 wt % SiO₂, but is not limited thereto. In another embodiment, the sol-gel is a mullite sol-gel that contains: 71.79 wt % Al₂O₃, and 28.21 wt % SiO₂, but is not limited thereto. The step for impregnating the refractory material may be performed under vacuum (e.g., in a vacuum chamber), under pressure (e.g., in a pressurized chamber), or a combination of both vacuum and pressure to accelerate impregnation of the refractory protection material. Vacuum is not limited, but is preferably selected greater than or equal to about −27 inches of Hg. Pressures are also not limited, but pressures greater than or equal to about 35 psi are preferred to accelerate the impregnation process. In highly porous refractory materials, a pressure less than or equal to about 35 psi may be selected. The method can further include the step of drying the impregnated refractory material for a preselected time at a preselected temperature to dry the impregnation material. The dried impregnation material is amorphous or partially crystallized. The method can further include the step of densifying the dried, impregnated refractory material for a preselected time at a preselected temperature to form a dried and densified impregnated refractory material. The dried and densified impregnation material is fully or partially crystallized, or in an amorphous form and has a melting temperature above about 1600° C. Temperatures used in conjunction with the densification step can vary depending on the selected sol-gel mixture. For example, in one embodiment, a sol-gel mixture that includes about 30 wt % leucite is used in combination with a densification temperature of about 1100° C. In another embodiment, for a sol-gel mixture is used that includes about 30 wt % mullite in combination with a densification temperature of about 1200° C. Times can vary and are not limited. In one embodiment, a densification of about an hour is used. The densification step can be performed in a furnace, or in a gasifier during start-up of the gasifier after installation of the impregnated refractory material.

The invention also includes another method for protection of a refractory material, characterized by the step of: impregnating defects on the surface and/or the interior of a refractory material in whole or in part with an impregnation material.

A more complete appreciation of the invention will be readily obtained by reference to the following description of the accompanying drawings in which like numerals in different figures represent the same structures or elements.

### BRIEF DESCRIPTION OF THE DRAWINGS

FIGS. 1a-1c show steps for protection of a refractory material in accordance with the invention.

FIGS. 2a-2b show the progression of penetration of a slag material in a refractory material treated in accordance with the invention.

FIG. 3 shows the change in viscosity of a Wyoming PRB® slag as a function of temperature with and without addition of an impregnation material.

FIG. 4 shows the increase in viscosity of a Wyoming PRB® slag mixed with a preselected mullite impregnation material as a function of time and temperature.

FIG. 5 shows the average penetration depth of Pittsburgh No. 8® coal slag in various refractory materials and in a refractory material (Serv 95®) treated in accordance with the invention.

### DETAILED DESCRIPTION OF THE INVENTION

The present invention includes a method and a composition that protects refractory materials and refractory surfaces in a coal gasifier from breakdown (e.g., spelling) caused by the penetration of corrosive slags that are generated in the gasifier into the refractory. The term “spalling” as used herein refers to the process whereby fragments of a refractory material are broken off from an edge or face of the refractory as a consequence of penetration by a slag into defects on the surface and/or the interior of the refractory. Service life of, e.g., high-chromium [e.g., 78.1% to 95.5% Cr₂O₃] refractory materials (e.g., refractory bricks) used in slagging coal gasifiers and coal combustion power plants can be extended in conjunction with the invention described herein by impregnating defects (e.g., open pores and channels) on the surface and/or the interior of the refractory with an impregnation material. The invention can also protect materials under other aggressive environments including, e.g., materials in steel or metals/alloys processing; aerospace operations; molten salt systems and processes; sealing of geological formations to prevent leaking of gaseous species (e.g., CO₂ sequestration) and fluids; and repairing of high-performance engineering materials in service that extends performance and service lifetimes. Impregnation materials suitable for protection of refractory materials in conjunction with the invention include crystalline compounds including, but not limited to, e.g., leucite, mullite, silica (including, e.g., cristobalite, tridymite, and other silica phases), SiAlON, AlN, Si₃N₄, including combination of these compounds; high melting temperature glasses including, but not limited to, e.g., potassium aluminosilicate and silica glasses. The term “high” as used herein means a melting temperature greater than about 1600° C. Crystalline materials are composed of solid crystals. Polycrystalline materials are composed of two or more crystalline materials. Amorphous materials are materials having an absence of crystalline structure, or an absence of long-range ordered structural material peaks as determined, e.g., by X-ray Diffraction (XRD). Exemplary crystalline compounds tested in conjunction with the invention include, but are not limited to, e.g., leucite (KAlSi₂O₆) and mullite (Al₆Si₂O₁₃). Other materials include, but are not limited to, e.g., silica (including, e.g., cristobalite, tridymite, and other silica phases), SiAlON, AlN, Si₃N₄, including combination of these compounds SiAlON; Si₃N₄. Combinations of these various materials can also provide protection of refractory materials. While the present invention is described herein with reference to these two preferred impregnation materials, it should be understood that the invention is not limited thereto, and various alternatives in form and detail may be made therein without departing from the scope of the invention. In a preferred method, the selected impregnation material is prepared as a sol-gel using a sol-gel method described further herein.

### Preparation of Sol-Gels for Refractory Material Protection

The impregnation materials used in conjunction with the invention are preferably prepared as low-viscosity (<2 Pa.s) sol-gels. The term “sol-gel” means a jelly-like material or colloid mixture that forms when sol particles are dispersed into a suitable quantity of a preselected liquid. The sol-gel process described herein is a chemical-solution deposition, or wet-chemical, technique. The term “sol” as used herein means a particle of a preselected size that is suspended in a liquid. Impregnation materials are preferably introduced as sols into a solvent that forms a low-viscosity sol-gel or low-viscosity colloidal fluid mixture. The sol component of the sol-gel impregnation mixture is preferably composed of particles of a size below a micrometer. More particularly, sols are of a size in the range from about 10 nm to about 100 nm. Solvent is preferably an environmentally friendly solvent, e.g., an aqueous-based solvent, but is not limited thereto. A sufficient quantity of solvent is used to form the sol-gel, typically about 60% by weight, but is not intended to be a limiting quantity. Viscosity is selected such that the impregnation material at least partially fills defects on the surface and/or the interior of the refractory material. Viscosity of the sol-gel mixture is preferably in the range from 1 Pa.s to about 2 Pa.s to allow ease of impregnation (treatment) of the refractory material, but is not limited thereto.

### Refractory Protection

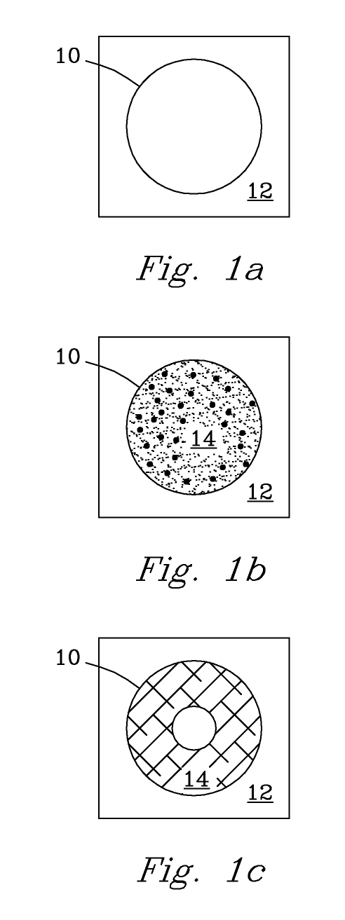

FIGS. 1a-1c show principle steps for protection of a refractory material, according to a preferred embodiment of the invention. FIG. 1a shows a representative defect 10 on the surface and/or the interior of a refractory material 12. Defects include, but are not limited to, e.g., flaws; cracks; pores; interconnected pores; inclusion; occlusions; cavities; channels; depressions; grooves; holes; features; including combinations of these defects. In FIG. 1b, defects 10 on the surface and/or the interior of a refractory material 12 are impregnated (treated) with an impregnation material 14, whereby the defect is at least partially filled with the impregnation material. Impregnation material 14 is preferably prepared as a sol-gel or colloidal fluid mixture with a preselected viscosity (e.g., 1-2 Pa.s), as described previously herein. Methods for impregnating (treating) the refractory 12 with impregnation material 14 include, but are not limited to, e.g., immersing, spraying, coating, brushing, pressurizing, evacuating, infusing, and combinations of these methods. As an example, refractory material 12 is impregnated by immersing the refractory material, e.g., in a tank containing the impregnation material 14 (e.g., as a sol-gel or colloidal mixture). Time required to impregnate (treat) the refractory material 14 need only be sufficient to at least partially fill defects 10 on the surface and/or the interior of refractory material 12. Impregnation of the refractory material can be performed under vacuum (e.g., in a vacuum chamber) or under pressure (e.g., in a pressurized chamber) or a combination of both vacuum and pressure to accelerate the impregnation of the refractory protection. Vacuum is not limited, but is preferably selected greater than or equal to about −27 inches of Hg. Pressures are also not limited, but pressures greater than or equal to about 35 psi are preferred to accelerate the impregnation process. In highly porous materials, a pressure under 35 psi may be preferred. Treatment times are not limited and will depend on the selected impregnation approach. For example, a treatment time of at least about 20 minutes is customary, but is not limited thereto. In FIG. 1c, defects 10 on the surface and/or the interior of refractory material 12 that are filled or at least partially filled with impregnation material 14 can be subsequently dried at a minimum temperature of, e.g., 105° C. for a time sufficient to remove physically bound water. Drying the refractory material 12 serves to immobilize impregnation material 14 within defects 10. An average drying time of a few hours can also be used, but again, times are not limited. Refractory material 12 can also be densified at a temperature of from about 1100° C. to about 1200° C. Times used for densification are not limited. A densification time of at least about an hour is exemplary. Densification of the impregnated refractory material 12 densities (hardens) the impregnation material 14 within defects 10 of refractory material 12 in a form that is crystalline, polycrystalline, or amorphous.

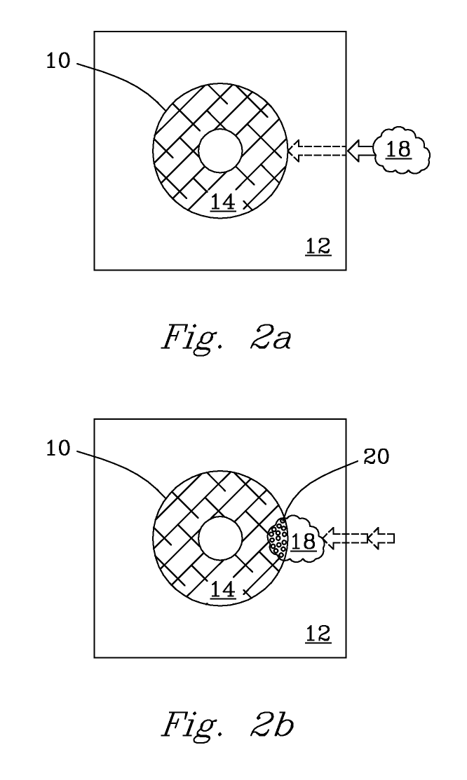

FIGS. 2a and 2b illustrate the process whereby protection is provided to refractory material 12 at an operating condition (e.g., 1600° C.), e.g., in a coal-fired gas reactor (gasifier). FIG. 2a illustrates a condition just prior to contact between molten slag 18 and impregnation material 14 present in an amorphous, crystalline, or polycrystalline form within defects 10 on the surface and/or the interior of refractory material 12 at the operating condition of the reactor. As illustrated in FIG. 2b, as slag 18 contacts defects 10 on the surface and/or the interior of the refractory, (densified) impregnation material 14 mixes with slag 18 to form a viscous impregnation material/slag mixture 20 that prevents penetration of the slag into defects 10, thereby minimizing spalling of refractory material 12. When treated with the selected impregnation material (i.e., containing preselected refractory protection compounds), the impregnated (treated) refractory material when present, e.g., in a gasifier at the operating temperature of the gasifier (1300° C. to 1600° C.), reacts with slag and results in an increase in the viscosity of the slag at the operating temperature. In exemplary tests described herein, viscosity of a Wyoming PRB® slag increases in a leucite impregnated refractory by a factor of from about 3 to about 7, and increases in a mullite impregnated refractory by a factor of from about 4 to about 29 in the temperature range from about 1350° C. to about 1525° C., if the mass distribution within the impregnated pore of the refractory material upon contact with slag is: 1) about 30 wt % mullite and 70 wt % Wyoming PRB slag, or 2) about a 30 wt % mixture containing leucite crystals and potassium aluminosilicate glass and 70 wt % Wyoming PRB® slag. The increase in viscosity of the slag melt decreases the ability of the slag to penetrate into, and damage or further damage (e.g., by spalling), the refractory, thereby increasing the service lifetime of the refractory material.

In an alternate refractory protection approach, crystalline forms of compounds selected from, e.g., leucite (KAlSi₂O₆); mullite (Al₆Si₂O₁₃); AlN; silica (including, e.g., cristobalite, tridymite and other polymorphs of silica), SiAlON, Si₃N₄, and combinations of these compounds can be impregnated (e.g., in an aqueous or organic solvent) directly into defects on the surface and/or the interior of a refractory material. Particles of the crystalline compounds are of a preselected size. In particular, particles are of a size below about a micrometer. More particularly, particles are nanometer-sized particles. Further, particles will be selected that are, e.g., spherical or round having a minimum number of jagged or sharp surfaces that can traverse the tortuous path within a refractory that will permit the particles to locate within defects of the refractory. Once impregnated within defects on the surface and/or the interior of the refractory, impregnation materials can then be densified at preselected densification temperatures that will yield the desired amorphous, crystalline, and/or polycrystalline forms of the densified impregnation materials. All approaches that will be selected by those of ordinary skill in the art in view of the disclosure are within the scope of the invention. No limitations are intended.

### Viscosity Measurements

Viscosity was measured as a function of temperature for various test slags. The Arrhenius equation [ln (η)=A+B/T] is applied to measured viscosity (η) versus temperature (T) data of tested slags, and the Arrhenius coefficients (A) and (B) were expressed as linear functions of the glass composition. The model was validated using viscosity data collected from the literature for compositions within the composition space of statistically designed slags. The model to predict viscosity of coal slags compares well with other models, e.g., Browning et al. (G. J. Browning, G. W. Bryant, H. J. Hurst, J. A Lucas, and T. F. Wall, An Empirical Method for the Prediction of Coal Ash Slag Viscosity, Energy & Fuels 2003, 17, 731-737). TABLE 1 lists chemical compositions of typical coal slags in wt % of oxides.

TABLE 1
Chemical Compositions of Coal Slags in wt % of Oxides.

| Components | Pittsburgh No. 8 ®^{a} | Wyoming PRB ®^{b} |
|---|---|---|
| SiO₂ | 46.77 | 43.47 |
| Al₂O₃ | 24.67 | 17.27 |
| CaO | 5.50 | 22.79 |
| MgO | 1.07 | 4.02 |
| Fe₂O₃ | 17.26 | 6.33 |
| TiO₂ | 1.02 | 1.41 |
| Na₂O | 1.00 | 1.71 |
| K₂O | 1.84 | 0.50 |
| P₂O₅ | 0.32 | 2.51 |
| Cr₂O₃ | 0.22 | 0.00 |
| SrO | 0.18 | 0.00 |
| BaO | 0.11 | 0.00 |
| PbO | 0.05 | 0.00 |
| Total | 100.00 | 100.00 |

^{a}M. S. Oh, D. D. Brooker, E. F. de Paz, J. J. Brady, T. R. Decker: “Effect of crystalline phase formation on coal slag viscosity”; Fuel Processing Technology, vol. 44, 1995, p 191-199.
^{b}Y. Chen, N. Shah, F. E. Huggins, G. P. Huffman: “Transmission Electron Microscopy Investigation of Ultrafine Coal Fly Ash Particles”; Environ. Sci. Technol., vol. 39, 2005, p 1144-1151.

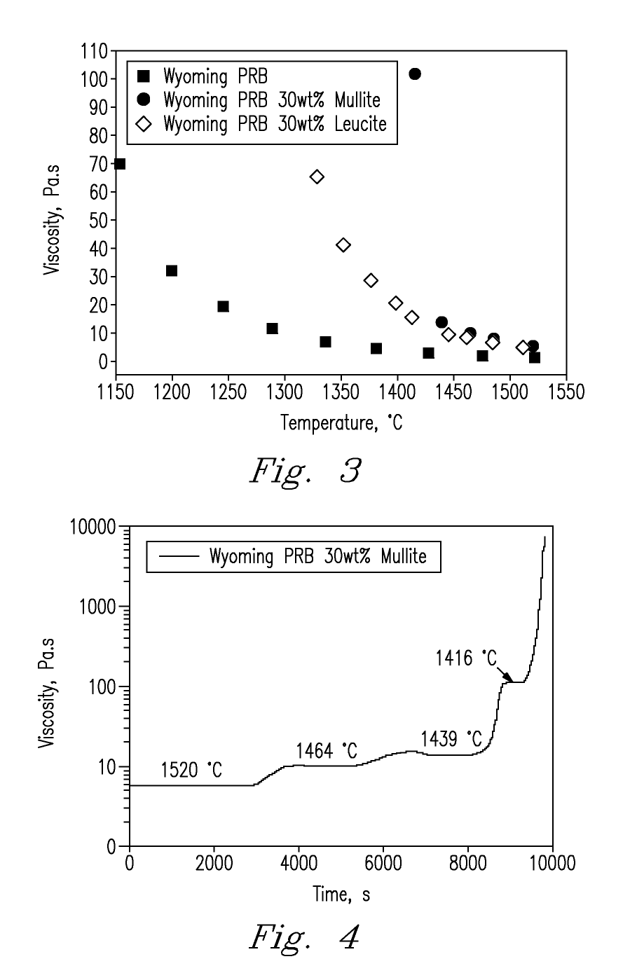

FIG. 3 plots the change in viscosity as a function of temperature for a mixture containing 70 wt % Wyoming Powder River Basin® (Wyoming PRB®) slag mixed with 30 wt % impregnation material [composed of 100 wt % mullite (Al₆Si₂O₁₃) crystals], or a mixture of 30 wt % leucite (KAlSi₂O₆) crystals and potassium aluminosilicate glass, as compared with an untreated slag. Mullite in the impregnation material was present as a crystalline material; leucite in the impregnation material was present as a crystalline material in an amorphous potassium aluminosilicate glass. Viscosity was measured in a vertical tube furnace equipped with a rotary viscometer. In the figure, untreated PRB slag has a viscosity of about 6.5 Pa.s at 1350° C. and a viscosity of about 1.3 Pa.s at 1525° C. In contrast, the mixture containing 70 wt % slag and an impregnation material containing a 30 wt % mixture of leucite crystals and potassium aluminosilicate glass has a viscosity of close to 43 Pa.s at 1350° C., and a viscosity of 3.9 Pa.s at 1525° C. At these temperatures, viscosity of the mixture is about 7 times greater at the low temperature and 3 times greater at the high temperature compared to the untreated slag. The mixture containing slag (70 wt %) and 30 wt % mullite impregnation material has a viscosity of about 102 Pa.s at 1416° C. and a viscosity of about 8 Pa.s at 1525° C. At these temperatures, viscosity of the mixture is more than 29 times greater than the untreated slag at 1416° C. and more than 4 times greater at 1525° C. These exemplary results demonstrate a significant viscosity difference for treated and untreated slags. Treated slags exhibit a viscosity at least about 3 times greater than untreated slags even at the highest operating temperatures. These viscosity differences are sufficient to minimize penetration of the slag into the refractory material and minimize spalling.

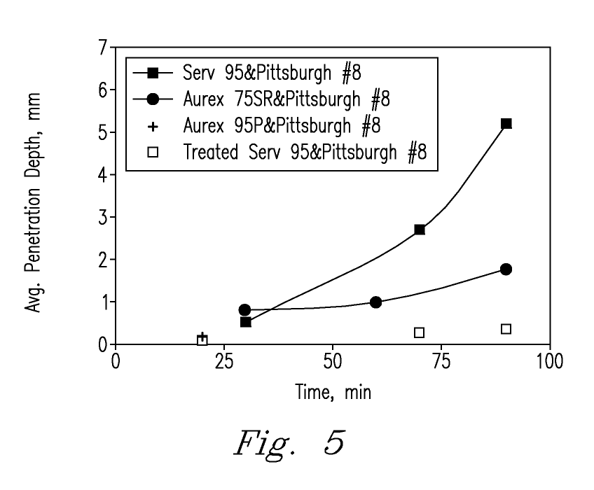

FIG. 4 shows the increase in viscosity of a Wyoming PRB® slag when mixed with an impregnation material composed of 100 wt % mullite crystals as a function of time and temperature. Mass distribution within the impregnated pore of the refractory material upon contact with slag was 30 wt % mullite and 70 wt % Wyoming PRB® slag. Viscosity was measured in a vertical tube furnace equipped with a rotary viscometer. In the figure, slag viscosity increases dramatically at 1416° C., corroborating results obtained in FIG. 3. The rapid increase in slag viscosity decreases the ability of the slag to penetrate into a refractory material (e.g., refractory bricks) when the refractory is impregnated with the impregnation material or the protection composition is otherwise applied, significantly increases the resistance of the refractory to spalling. TABLE 2 summarizes chemical compositions and apparent porosities for three exemplary refractories tested in conjunction with the invention: Serv 95®, Aurex 75SR®, Aurex 95P® (ANH Refractories Company, Moon Township, Pa., USA).

TABLE 2
Chemical Compositions and Apparent Porosities of Selected
Refractory Materials in wt % of Oxides. ^{a}

| | REFRACTORY | | |
|---|---|---|---|
| Components | Serv 95 ® | Aurex 75 SR ® | Aurex 95P ® |
| SiO₂ | 0.7 | 0.2 | — |
| Al₂O₃ | 3.2 | 20.0 | 4.7 |
| Fe₂O₃ | 0.1 | 0.3 | — |
| TiO₂ | 0.9 | 0.00 | — |
| Na₂O + K₂O | 0.2 | — | — |
| CaO | 0.2 | 0.3 | — |
| MgO | 0.2 | 0.1 | — |
| ZrO₂ | — | 1.0 | — |
| Cr₂O₃ | 94.5 | 78.1 | 92.0 |
| P₂O₅ | — | — | 3.3 |
| Total | 100.0 | 100.0 | 100.0 |
| Porosity | 20.0 | 14.9 | 12.5 |

^{a} ANH Refractories Company, Moon Township, PA, USA

Aurex 75 SR® is a chromia-alumina refractory with an apparent porosity of 14.9%, intended for use in low-wear areas of a gasifier. Aurex 95P® is a high-chromia refractory developed for use in higher-wear locations of a gasifier. Aurex 95P® contains >3 mass % of P₂O₅ and has the lowest apparent porosity (12.5%) of the three refractories tested. Serv 95® is a high-chromia refractory used in higher-wear locations. Serv 95® contains the highest concentration of Cr₂O₃ (94.5%) with the highest apparent porosity (20%) of the tested refractories. Refractory coupons were tested at selected temperatures and times to determine the penetration depth of slags into the refractory samples. The tests were carried out in a reducing atmosphere (i.e., in a gas mixture containing 998 mL/min of 2.7% H₂ balanced with Ar, and further containing 2 mL/min of CO₂; calculated pO₂=10⁻¹² atm at 1400° C.) to simulate the reducing conditions inside a commercial gasifier. A slag pellet was placed inside a zircon ring acting as a slag reservoir atop the refractory coupon surface. Coupons were placed in a mullite tube furnace and left in the cold zone at approximately 400° C. until the furnace reached the test temperature. Coupons were then pushed into the hot zone and monitored while the slag pellet melted. A test clock was started once the slag pellet had melted to be level with the top of the zircon ring. Slag penetration is uneven due to local variations in porosity (e.g., pore size, pore volume, and pore distribution) and tortuosity of defects within the refractory. Average penetration depths were estimated using digital image analysis software. TABLE 3 lists the average penetration depth of Pittsburgh No. 8® coal slag into a Serv 95® refractory, and effective diffusivity (D_{eff}) values for a range of temperatures.

TABLE 3
Penetration Data of Pittsburgh No. 8 ® Coal Slag into
Serv 95 ® Refractory.

| | Time at | Slag Penetration | Effective |
|---|---|---|---|
| Temperature | Temperature | Depth | Diffusivity |
| (K) | (min) | (mm) | (cm²/s) |
| 1648 | 90 | 2.36 | 5.15 × 10⁻⁶ |
| 1660 | 90 | 3.01 | 8.40 × 10⁻⁶ |
| 1673 | 90 | 5.20 | 2.50 × 10⁻⁶ |

Effective diffusivities (D_{eff}) were calculated using a mean penetration depth (h) of a one-dimensional (1D) diffusion front [e.g., as reported by Kirkaldy and Young in (“Diffusion in the Solid State”, Institute of Metals: London, 1987; p 49)], as given by equation [1]:

h=\sqrt{2D_{eff}t} [1]

Effective diffusivity conceptually encompasses all mechanisms of intrusion, such as capillary action, liquid-solid, solid-solid, solid-gas diffusion, and pressure-driven Darcian permeation. Fitting the effective diffusivity as a function of temperature using the Arrhenius equation gives equation [2]:

$${D}_{eff} ( T ) = {D}_{0} {e}^{- [ \frac{A}{RT} ]} \qquad [ 2 ]$$

Here, D_{eff}(T) is the effective diffusivity (cm²/sec); the pre-exponent D₀=5.683×1040 cm²/sec; the activation energy (A)=1454 kJ/mol; and the ideal gas constant (R)=8.314×10-3 kJ/° K mole. Substituting equation [2] into equation [1] gives an approximation of slag penetration depth as a function of temperature at steady-state operating conditions. Test temperatures were chosen high enough to give measurable slag penetration during the 90 minute duration of the tests. Such rapid penetration is not acceptable for gasifier operation and would require operating at a reduced temperature or using a different refractory that is more resistant to the ingress of this slag chemistry.

FIG. 5 shows the average penetration depth of Pittsburgh No. 8® coal slag in three refractory materials (Serv 95®, Aurex 75 SR®, Aurex 95P®), and a refractory material (i.e., Serv 95®) impregnated (treated) with an impregnation material in accordance with the invention. In the figure, average penetration depth achieved by Pittsburgh No. 8® slag in the Aurex 95P® refractory was approximately 0.2 mm after only 20 minutes of exposure at 1400° C. Average penetration depth achieved by Pittsburgh No. 8® slag in the Serv 75 SR® refractory was about 0.7 mm after 30 minutes of exposure at 1400° C. Penetration depth in the Serv 95® refractory increased to about 1.7 mm after 90 minutes of exposure. In the Serv 95® refractory, penetration by Pittsburgh No. 8® slag was observed beginning at about 30 minutes with an average penetration depth of about 0.6 mm. Average penetration depth was about 5.2 mm after 90 minutes of exposure. In comparison, after impregnation, average penetration by the Pittsburgh No. 8® slag in the Serv 95® refractory treated with an impregnation material (30 wt % mixture containing leucite crystals and potassium aluminosilicate glass) decreased to about 0.3 mm after 90 min at 1400° C. Test results demonstrate an increased resistance to slag penetration by a factor of greater than 17 times. Expectation is that treated refractory material may achieve even greater resistance to slag penetration by further optimization of the refractory protection scheme.

Sealing of Geological Formations/Carbon Sequestration

Methods and compositions of the invention described herein can be used to seal caprock and other permeable formations and materials, e.g., to seal CO₂ in Carbon Capture and Sequestration (CCS) environments. A suitable sol-gel mixture can be used to impregnate the selected caprock at the selected location, including other porous geologic formations. The sol-gel mixture can be dried, cured, heat-treated, and/or annealed in place. Compositions can be designed or tailored to fit the CCS conditions. Temperatures in CCS environments typically range from about 298 K (25° C.) to about 373 K (100° C.) and pressures typically in the range from about 1 MPa to about 30 MPa. However, chemistry and conditions are not limited.

Repairing of Structural Materials in Service

The method and compositions of the invention can be further used to repair structural materials that are currently in service to: 1) extend service lifetimes, 2) reduce failures of these materials, and 3) save money associated with repairs and replacements. Structural materials including, but not limited to, e.g., (partially or fully) stabilized zirconia; SiAlON (i.e., silicon aluminum oxynitride) ceramics; SiC; SiN; including combinations of these materials provide excellent erosion, corrosion and abrasion resistance along with temperature resistance, fracture toughness and strength. Components made of these materials exhibit superior corrosion and wear resistance that can be used in extreme environments and extreme service applications. Numerous applications for these materials are found in the chemical and petrochemical industries. Components made of these materials save money by reducing downtime and required maintenance. The methods and compositions of the invention can be applied to repair these materials and associated components made of these materials while remaining in a service environment with minimal interference. A suitable sol-gel mixture can be used to impregnate, e.g., corrosion defects such as pits, fine cracks, pores, and discontinuities in the structural material or component, and can further be dried, cured, and/or heat-treated in place. Composition and application conditions (temperature and pressure) can be designed to fit the specific service environment of the application. Chemistry and conditions are not limited.

The following Examples provide a further understanding of the invention.

### Example 1

### Refractory Protection

### (Leucite Sol-Gel Method #1)

A 250 mL beaker was heated to 90° C. in a silicone oil bath on a hot plate. 50 mL of deionized water was poured into the heated beaker. After ˜1 min, 32.8 mL of a LUDOX® SM-30 colloidal silica suspension (30 wt % suspension in water, ρ=1.22 g/cm³, Sigma-Aldrich, St. Louis, Mo., USA) was added into the 50 mLs deionized water and mixed for 1 minute with a platinum mixer (˜150 rpm). Then, 13 mL of KAlO₂ solution (49 wt % solids, ρ=1.54 g/cm³, Sigma-Aldrich, St. Louis, Mo., USA) was slowly added during continuous mixing. Mixture was stirred for ˜1 min to form the sol-gel mixture. A 90 g coupon of Serv-95® refractory (˜3.5 cm square and ˜1.5 cm thick) was introduced into the sol-gel mixture and placed into a dessicator. In-house vacuum (−27 in. of Hg) was then applied to impregnate the refractory coupon. The refractory coupon was allowed to soak in the sol-gel mixture under vacuum until no bubbles were observed coming from the refractory surface (˜10 min). After impregnation, the refractory coupon was removed from the gel, excess gel was removed, and the refractory coupon was placed in an oven and dried overnight at a temperature of 105° C. The impregnated and dried refractory was then heated at a temperature of 1100° C. for 1 hr to densify the impregnation material in the refractory.

### Example 2

### Refractory Protection

### (Leucite Sol-Gel Method #2)

A sol-gel mixture was prepared as in Example 1. A 90 g coupon of Serv-95® refractory (˜3.5 cm square and ˜1.5 cm thick) was introduced into the sol-gel mixture and placed into a pressurized vessel. A pressure of ˜35 psi was applied to impregnate the refractory coupon (˜20 min). After impregnation, the refractory coupon was removed from the gel, excess gel on the surface of the refractory was removed, and the refractory coupon was placed in an oven and dried overnight at a temperature of 105° C. The impregnated and dried refractory was then heated at a temperature of 1100° C. for 1 hr to densify the impregnation material in the refractory.

### Example 3

### Refractory Protection

### (Muilite Sol-Gel Method #1)

Aluminum hydroxide was completely precipitated from a >98 wt % aluminium-nitrate nonahydrate solution by adding ammonium hydroxide. The solution was filtered and precipitate was washed several times with water. Precipitated aluminum hydroxide was then dissolved in an aqueous oxalic-acid solution using excess oxalic acid (>99.5 wt %) (1:2 molar ratio) by warming in a water bath at 100° C. to obtain a clear aluminum oxalate solution. The aluminum oxalate solution was then dried to obtain a solid aluminum oxalate precursor. Next, 50.8231 g of solid aluminum oxalate precursor was dissolved in 80 mL of deionized water and heated in a 250 mL beaker in a silicone oil bath at 70° C. and stirred ˜1 min using a platinum mixer. 10 mL of >98 wt % tetraethoxysilane (TEOS) (ρ=0.933 g/cm³) (Fluke, St. Louis, Mo., USA) was added and the solution was then mixed for ˜30 min to form the sol-gel mixture. Impregnation and densification of the refractory coupon was performed as in Example 1, but at a densification temperature of 1200° C.

### Example 4

### Refractory Protection

### (Mullite Sol-Gel Method #2)

A mullite sol-gel mixture was prepared as in Example 3. A 90 g coupon of Serv-95® refractory was introduced into the sol-gel mixture and placed into a pressurized vessel. A pressure of ˜35 psi was applied to impregnate the refractory coupon (˜20 min). After impregnation, the refractory coupon was removed from the gel, excess gel on the surface of the refractory was removed, and the refractory coupon was placed in an oven and dried overnight at a temperature of 105° C. The impregnated and dried refractory was then heated at a temperature of 1200° C. for 1 hr to densify the impregnation material in the refractory.

### CONCLUSIONS

Results described herein demonstrate the feasibility and utility of increasing the service lifetime of refractory materials in, e.g., a slagging coal gasifier, by treating the refractory with high-temperature melting compounds. The same protection scheme and approach can be potentially applied to sealing of geological formations, e.g., for CO₂ sequestration, and repairing of engineering materials currently in service while operating in aggressive environments.

We claim:

1. A refractory protection composition, comprising:
at least about 10% by weight of a dried and/or densified impregnation material impregnated within defects on the surface and/or the interior of a refractory, said impregnation material is in an amorphous, crystalline, and/or polycrystalline form selected from the group consisting of: leucite (KAlSi₂O₆), mullite (Al₆Si₂O₁₃), AlN, silica and silica polymorphs, SiAlON, Si₃N₄, and combinations thereof.

2. The refractory protection composition of claim 1, wherein said impregnation material has a melting point temperature in the range from about 1600° C. to about 2200° C.

3. The refractory protection composition of claim 1, wherein said impregnation material further includes a high melting point temperature glass selected from the group consisting of: potassium aluminosilicate glasses, silica glasses, and combinations thereof.

4. The refractory protection composition of claim 1, wherein said impregnation material is impregnated as a sol-gel or colloidal mixture that includes one or more compounds selected from the group consisting of: Al(PO₃)₃, Al₂O₃, SiO₂, K₂O, P₂O₅, and combinations thereof.

5. The refractory protection composition of claim 4, wherein said sol-gel or colloidal mixture includes an aqueous or organic solvent.

6. The refractory protection composition of claim 4, wherein said sol-gel or colloidal mixture includes a particle of a size less than about a micrometer.

7. The refractory protection composition of claim 4, wherein said sol-gel or colloidal mixture includes a particle of a nanoparticle size.

8. The refractory protection composition of claim 4, wherein said sol-gel or colloidal mixture has a preselected viscosity of about 2 Pa.s or below.

9. The refractory protection composition of claim 1, wherein said dried and/or densified impregnation material when contacted by slag mixes with same and increases the viscosity and/or the melting point temperature, which decreases penetration of, and spalling induced by, said slag within said defects on the surface and/or the interior of said refractory material.

10. A method for protection of a refractory material, characterized by the step of:
impregnating at least a portion of defects on the surface and/or the interior of said refractory material with an impregnation material in a sol-gel or colloidal mixture containing one or more compounds selected from the group consisting of: Al(PO₃)₃, Al₂O₃, SiO₂, K₂O, P₂O₅, and combinations thereof.

11. The method of claim 10, wherein said sol-gel or colloidal mixture is prepared in an aqueous solvent.

12. The method of claim 10, wherein said sol-gel or colloidal mixture is prepared in an organic solvent.

13. The method of claim 10, wherein said sol-gel or colloidal mixture includes a particle of a size less than about a micrometer.

14. The method of claim 10, wherein said sol-gel or colloidal mixture includes a particle that is a nanometer-sized particle.

15. The method of claim 10, wherein said sol-gel or colloidal mixture has a viscosity below about 2 Pa.s.

16. The method of claim 10, wherein said sol-gel or colloidal mixture has a viscosity in the range from about 1 Pa.s to about 2 Pa.s.

17. The method of claim 10, wherein the step of impregnating said refractory material includes an impregnation time of at least about 5 minutes.

18. The method of claim 10, wherein the step of impregnating is performed under vacuum and/or pressure.

19. The method of claim 18, wherein the step of impregnating includes use of a vacuum greater than or equal to about −27 in. of Hg.

20. The method of claim 18, wherein the step of impregnating includes use of a pressure greater than or equal to about 35 psi.

21. The method of claim 18, wherein the step of impregnating includes use of a pressure less than or equal to about 35 psi.

22. The method of claim 10, further including the step of drying said impregnated refractory material to secure said impregnation material within said defects on the surface and/or interior of said refractory material.

23. The method of claim 22, wherein the step of drying includes use of a drying temperature of at least about 50° C.

24. The method of claim 10, further including the step of densifying said impregnated refractory material to form a densified impregnation material within said defects on the surface and/or interior of said refractory material that includes at least about 10% by weight of an amorphous, crystalline, and/or polycrystalline compound selected from the group consisting of: leucite (KAlSI₂O₆); mullite (Al₆Si₂O₁₃); AlN; silica and silica polymorphs, SiAlON, Si₃N₄, and combinations thereof.

25. The method of claim 24, wherein the step of densifying includes use of a densification temperature selected in the range from about 110° C. to about 1500° C.

26. The method of claim 24, wherein the step of densifying includes use of a densification time of at least about 20 minutes.

27. The method of claim 24, wherein said densified impregnation material further includes a high-melting temperature glass selected from the group consisting of: potassium aluminosilicate glasses, silica glasses, and combinations thereof.

28. The method of claim 24, wherein said densified impregnation material within said defects on the surface and/or the interior of said refractory material has a melting point temperature in the range from about 1600° C. to about 2200° C.

29. The method of claim 24, wherein said densified impregnation material mixes with a slag material when contacted by same, increasing the viscosity and/or the melting point temperature thereof, thereby minimizing spalling of said refractory material induced by penetration of said slag within said defects on the surface and/or the interior of said refractory material at a preselected operation temperature.

30. The method of claim 29, wherein said densified impregnation material increases viscosity of said slag material contacted by same by at least an order of magnitude.

31. The method of claim 29, wherein said densified impregnation material increases the melting point temperature of said slag contacted by same to greater than or equal to about 1600° C.

32. The method of claim 29, wherein said densified impregnation material increases the melting point temperature of said slag contacted by same by at least about 100° C.

33. The method of claim 29, wherein said densified impregnation material minimizes penetration of said slag to a maximum depth within said defects on the surface and/or interior of said refractory in the range from about 0.3 mm to about 5 mm.

34. The method of claim 24, wherein said refractory material containing said densified impregnation material is used as a component of a slagging coal gasifier.
